(19) United States
(12) Patent Application Publication
(10) Pub. No.: US 2024/0202804 A1
(43) Pub. Date: Jun. 20, 2024

(54) SYSTEM AND METHOD FOR COLLECTING ITEM LOCATION INFORMATION BASED ON CROWD-SOURCED DATA

(71) Applicant: NCR Corporation, Atlanta, GA (US)

(72) Inventors: Kip Morgan, Atlanta, GA (US); Andrew Reusche, Roswell, GA (US); Monte Schultz, Canton, GA (US)

(21) Appl. No.: 18/083,411

(22) Filed: Dec. 16, 2022

(51) Int. Cl. G06Q 30/0601; G01C 21/20; G06Q 30/0208

(52) U.S. Cl. CPC G06Q 30/0639; G01C 21/206; G06Q 30/0208

(57) ABSTRACT

A system and method are disclosed for identifying item locations via crowd-sourced information. The system includes a server having a processor and a non-transitory computer-readable storage medium. The server is coupled to a mobile shopping application on a mobile device of a user. The processor performs a series of operations constituting the following method. The user of the mobile shopping application on the mobile device is selectively requested to locate an item in a retail store via the mobile shopping application. The user is directed to an expected location of the item via the mobile shopping application. Confirmation is received from the user that the item has been located via the mobile shopping application. The precise location of the item is captured in conjunction with the mobile shopping application. An item location database is updated to include the captured precise location of the item.

### FIELD

This disclosure relates to a system and method for collecting item location information based on crowd-sourced data, and more particularly to a system and method that collects item location information from users of a mobile shopping application. The users may preferably be offered incentives for supplying the item location information.

### BACKGROUND

Modern retail establishments, such as grocery stores or department stores, stock thousands of product items. Some items may be stocked by employees and other items may be stocked by a third-party such as a vendor's representative. The retailer may allot locations for certain types of products, but the precise location of particular products may change over time as the employees and vendor representatives shift their locations. Furthermore, some products may be positioned at more than one location within a store (e.g., when products offered at a sale price are located at a position close to the checkout registers in addition to their normal spot). The vast number of products available in a retail establishment can present a difficulty for shoppers looking for a particular product, for third-party pickers that need to work as efficiently as possible to locate the items needed to satisfy a current order, and for the retailers themselves who need to manage and maintain an inventory of the current store stock. The retailers also need to limit labor costs that could be incurred based on the need to periodically conduct manual product location audits to ensure that internal stock location maps are up to date.

Accordingly, because of the foregoing difficulties in obtaining and maintaining stock location information in retail establishments, there is a need for a better way to acquire up-to-date stock location data.

### BRIEF DESCRIPTION OF THE DRAWINGS

The following detailed description, given by way of example and not intended to limit the present disclosure solely thereto, will best be understood in conjunction with the accompanying drawings in which:

FIG. 1 is a diagram of a system for an indoor wayfinding interface and service;

FIG. 2 is a diagram of a method for indoor wayfinding;

FIG. 3 is a diagram of another method for indoor wayfinding;

FIG. 4 is a diagram of a system for an indoor wayfinding interface and service adapted to implement the system and method for collecting item location information of the present disclosure;

FIG. 5 is a flowchart showing a method for collecting item location information of the present disclosure;

FIG. 6 is a drawing showing a user-operated device operating in accordance with the system and method for collecting item location information of the present disclosure; and

FIG. 7 is a drawing showing a user-operated device operating in accordance with an additional feature of the system and method for collecting item location information of the present disclosure.

### DETAILED DESCRIPTION

In the present disclosure, like reference numbers refer to like elements throughout the drawings, which illustrate various exemplary embodiments of the present disclosure.

Finding items in a retail establishment takes time. The system and method of the present disclosure provides a way to crowdsource item location data using indoor augmented reality wayfinder technology. The collected item location data can then be used by the augmented reality wayfinder system to give users thereof more reliable directions to the locations of desired items.

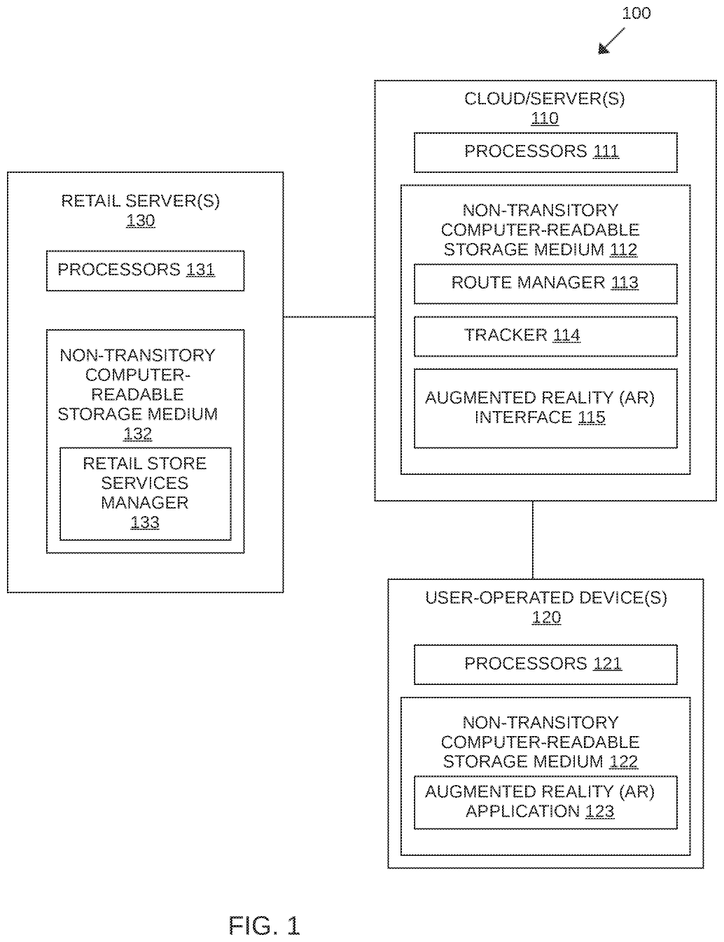

FIG. 1 is a diagram of a system/platform 100 for indoor route mapping based on indoor augmented reality wayfinder technology, according to an example embodiment. It is to be noted that the components are shown schematically in greatly simplified form, with only those components relevant to understanding of the embodiments being illustrated. Furthermore, the various components (that are identified in system/platform 100) are illustrated and the arrangement of the components are presented for purposes of illustration only. It is to be noted that other arrangements with more or less components are possible without departing from the teachings of providing indoor wayfinding, presented herein and below.

System/platform 100 (hereinafter “system 100”) provides a processing environment by which a customer is provided an Augmented Reality (AR) based wayfinding interface and service for navigating a route within a given indoor location. The customer operates a customer device having an integrated camera that provides a video of a physical environment in real time on the customer device as the customer travels a provided route that includes one or more desired destinations of the customer. The interface superimposes a variety of visual cues onto the video stream being viewed by the customer. The size, shape, and/or color of the visual cues may dynamically change as the customer is nearing a turn in the route or nearing a desired destination along the route, thereby providing the customer with useful and intuitive wayfinding guidance as the customer travels the route to one or more desired destinations along the route. Additionally, when the customer is within a preconfigured distance of a turn along the route or within the preconfigured distance of a desired destination along the route haptic/vibration-based feedback can be provided through the interface for processing on the customer device to further alert the customer to the turn or the desired destination.

Once a customer reaches a desired destination along the route or reaches a next turn along the route, the wayfinding AR interface updates the visual cue for a next turn along the route or a next desired destination along the route. Still further, if a desired destination along the route is a desired item of a store, the video being viewed by the customer through the customer device is processed to detect the item within the video and highlight or provide a rendering of the item within the video, such that the customer can quickly identify the item within the physical environment of the customer, pick the item, and move to a next desired item or a next turn along the route.

As used herein, the terms “customer,” “consumer,” “user,” “staff member,” “employee,” and/or “picker” may be used interchangeably and synonymously herein and below. These terms may refer to an individual who is engaged in an AR wayfinding session with system 100.

The phrase “Augmented Reality (AR)” is intended to mean a blending of actual physical objects present within an environment of a user and digitally generated objects (or otherwise non-real-world objects) that are superimposed into the environment within a video as the video is captured in real time by a camera of a user-operated device as the user operates and travels with the device.

An “object” is intended to mean an electronically identified real-world structure (shelf, aisle, door, chair, terminal, desk, display, device, etc.) or a real-world item that is identified within the physical environment of the user from a video of the user-operated device for purposes of identification during an AR wayfinding session (e.g., a physical/real-world object). An object may also be an AR rendering of a physical object or an AR rendering of a shape, symbol, text, graphic, and/or animation (“AR object”) that is independently generated and provided within the video during the user's AR wayfinding session but that is not present within the physical environment of the user during the AR wayfinding session.

An “AR wayfinding session” refers to a communication session during which the user is provided a route or path to one or more items at a given location and AR-based wayfinding route guidance is provided to the user through the indoor location via an AR app of a user-operated device. An integrated camera of the user device captures real-time video being viewed by the user as the user travels the route through the indoor location to the item(s). One or more AR objects that dynamically change based on the user's tracked location along the route relative to a desired item or a turn along the route are blended into the video being viewed by the user as the user traverses the route to the item(s). Additionally, the user device can be instructed to provide a variety of haptic/vibration feedback as additional wayfinding guidance as the user travels through the indoor location and navigates the route to the item(s).

System 100 defines routes or walking paths through an indoor location to one or more items as a sequence of points. If a given retailer already has the ability to provide valid walking paths, such paths are converted into records comprising a sequence of nodes where each record is a valid walking path within a given store of the retailer. Typically, any existing walking path of a retailer is not a straight line (rather it is comprised of a series of straight lines and turns), such that when a walking path is converted into the record, each turn associated with the existing walking path is identified as a node within the record and represented within the record as a collection of legs or segments that are straight lines between nodes.

When a user is engaged in an AR wayfinding session for a given indoor location, a route or path is provided to an AR app on the user device via a route manager. The path corresponds to a record associated with the path. As the user begins to walk the path, the location of the user is tracked relative to the current segment of the record for the path using an AR-based distance algorithm and AR-rendered objects are superimposed onto the video to provide real-time feedback through novel wayfinding guidance.

For example, a dynamically changing AR object (such as a three-dimensional (3D) arrow is superimposed into the video that the user is viewing while walking. The arrow points in the direction that the user is to walk for the current segment. A next node in the path for which the user is to turn is also rendered into the video as a second AR object (such as a sphere). The 3D arrow points to the sphere within the video being viewed by the user. The distance of the user to the next node is tracked using an AR algorithm to dynamically change attributes of the sphere and/or arrow within the video as the user travels closer to the next node. As an AR-tracked distance between the user and a next node decreases, the sphere is colored different variations of red providing real-time visual cues to the user that the user is walking in the correct direction towards the next node of the path. As tracked distance between the user and the next node increases, the sphere is colored different shades of blue providing real-time visual cues to the user that the user is walking away from or in the incorrect direction needed for the next node.

AR distance detection is used for dynamically changing the color of the sphere within the video being viewed by the user on the user device as the user moves through the indoor location. When the user is tracked to be within a predefined distance of the node, the 3D arrow changes and/or the sphere changes for the next node along the path and haptic/vibration feedback may be provided through the user device, such as vibrations indicating a turn is coming up or needed at this juncture along the path.

It is noted that the 3D arrow may also change colors to indicate the distance the user is from the sphere or the next node, and the angle of the arrow can also change slowly as the user moves toward the next node to reflect the direction of the turn that is approaching at the next node using the user device's accelerometer. In this case, the sphere may or may not be used with the arrow as discussed above.

When a user reaches the next node, the next leg or segment of the path is pulled from the record and the process iterates until the path is completely traversed. Further, as the user traverses the path and items are to be picked, the item to be picked can be detected on a shelf from the video and an AR-generated object or rendering of the item is presented within the video to the user to highlight the location of the item on the shelf.

Furthermore, a current distance of the user from a next node may be superimposed onto the video with the 3D arrow as the user walks toward the next node. Additionally, the size (another AR object attribute besides color) of the node can become smaller and larger as the user moves toward the next node.

Moreover, if an item is to be picked for a given segment of the path, the user's video can display the item along with its location below the video on the user device within the AR app. For example, a portion of the screen on the user device below the video may include item information for an item that is to be picked for the users current segment along the path, such as a text message with an image of the item stating that a specific brand of canned tomatoes is to be picked and is located in this segment at aisle X bin Y along with a quantity to pick (e.g., N cans).

It is within the above-noted context that system 100 is now discussed in detail with reference to FIG. 1. System 100 comprises a server 110 (which may be cloud-based), a plurality of user-operated devices 120, and one or more retail servers 130. Server 110 comprises at least one processor 111 and a non-transitory computer-readable storage medium 112. Medium 112 comprises executable instructions for a route manager 113, a tracker 114 (i.e., a tracker module), and an AR router interface 115. The executable instructions when provided to and executed by processor 111 from medium 112 cause the processor 111 to perform the processing discussed herein and below for route manager 113, tracker 114, and AR router interface 115.

Each user-operated device 120 (hereinafter “user device 120”) comprises at least one processor 121 and a non-transitory computer-readable storage medium 122. The non-transitory computer-readable storage medium 122 comprises executable instructions for an AR application (app) 123. The executable instructions when provided to and executed by the processor 121 from the non-transitory computer-readable storage medium 122 cause the processor 121 to perform the processing discussed herein and below for AR app 123.

Each retail server 130 comprises at least one processor 131 and a non-transitory computer-readable storage medium 132. The non-transitory computer-readable storage medium 132 comprises executable instructions for a retail store services manager 133. The executable instructions when provided to and executed by processor 131 from the non-transitory computer-readable storage medium 132 cause processor 131 to perform the processing discussed herein and below for the retail store services manager 133, which is optional.

Route manager 113 uses an API to interact with retail store services manager 133 to obtain a path for a given user (e.g., a customer, a store employee, an inventory stocker, a third-party picker) and one or more items associated with the path that the user desires to pick/stock from the store for an order. Route manager 113 converts the path into a record that comprises entries, each entry in the record being associated with a straight-line segment and two nodes, and each record also being associated with the user (such as through a mobile device identifier for the user device 120 and/or a user identifier for the user). The first node of the record is identified as an entry point into the retail area of the store (note, for a store employee, this may be a door that leads from any employee area into the retail area of the store, such that the entry point does not necessarily have to be an ingress point for customers). Once the path, the associated items, and the user or order identifying information is obtained and converted into the record for the path, system 100 is ready for the user to being their trip/journey along the path The trip along the path within the store can be initiated for the user in a variety of manners.

For example, a barcode, Quick Response (QR) code, or a unique image may be positioned at first nodes within the store that provide access to the retail area of the store, the user opens AR app 123 on the user device 120 and the integrated camera is activated and viewable through a screen of a user-facing interface of AR app 123. The user directs a focus of the camera to the barcode or QR code and AR app 123 sends a message to AR router interface 115 with the barcode, a device identifier for device 120, and, optionally, a registered user identifier associated with the user. The message is provided to route manager 113 by AR router interface 115. Route manager 113 decodes the barcode or QR code and identifies the retail store and the entry node into the retail store. Route manager 113 uses the device identifier and/or user identifier to identify the order and retrieve the record associated with the path and the items that are being picked/stocked for the order.

In another case, AR app 123 reports its location directly to route manager 113 when it detects that the user device 120 is at the retail store. Route manager 113 uses the location of the user device 120 and checks for any orders associated with the user identifier for the user registered to the device identifier for the user device 120. Route manager 113 pulls the record.

It is noted that other approaches may be used as well for a record (path and items for a given retail store) to be associated with a user and/or a user device 120 and pulled for an AR waypoint session of system 100.

Once the user device 120 is identified at the first node of the retail area of the store and properly associated with an order defined in a record as a path through the store to pick/stock items of the store, AR router interface 115 establishes and initiates an AR waypoint session with the user device 120 and AR app 123. AR router interface 115 also initiates the tracker 114.

Tracker 114 may utilize an AR-based distance and tracking algorithm that tracks user movements and corresponding movements of the user device 120. The tracker 114 may utilize settings and states associated with various sensors of the user device 120 (e.g., the device's camera, gyroscope, accelerometer, or depth sensors such as a light detection and ranging (LIDAR) sensor, an infrared (IR) sensor, or the like) and analysis of the real-time video captured by the camera to calculate distances and directions of device movements within a physical environment of the user relative to a starting point for which distance and tracking was initiated on the device (the first node of the path for the user).

The record associated with the path for the AR waypoint session also comprises distances between each node or a distance for each segment. This allows tracker 114 to subtract the total distance between two given nodes based on the calculated distance that the user device 120 is tracked as having traveled by the AR-based distance and tracking algorithm. So, when the user begins the session at the first node (entry point into the retail area of the store) at the start of the AR waypoint session and begins to travel along the route, the known length of the first segment to the second node is obtained, and as the user device 120 continues traversing the route, a remaining length of the segment is calculated by subtracting the distance the user device 120 is determined to have traveled from the known length of the first segment. The remaining length of the segment and the direction of the user device 120 are reported in real time to AR router interface 115.

AR router interface 115 generates one or more AR objects, such as the 3D arrow discussed above and/or the sphere discussed above, and changes attributes of the AR object(s) based on the current direction of travel of the user device 120 and based on the remaining length of the current segment. For example, the size of the object(s) correlates to the remaining distance to the next node and the color of the object(s) correlates to the remaining distance to the next node. The current remaining distance to the next node may also be provided with the AR object(s) as a component of the AR object. For example, the 3D arrow may include a text string that indicates the current remaining distance to the next node is 2.5 meters. The text string may be viewed as an additional attribute of the AR object, which continuously changes as the user travels based on the tracker-provided distance to the next node. A variety of other information associated with a given entry of the record may also be provided by AR router interface 115 to AR app 123 for the current segment, such as an object that comprises an image and text of an item that is to be picked/stocked along the current segment. For example, an item object may comprise an image of a specific brand of product along with written text stating its specific aisle and bin number and the quantity that is to be picked.

In an embodiment, AR router interface 115 also provides an AR object that visually depicts multiple segments for the path within a graphical rendering of a map for the store along with the current location of the user within the current segment. This AR object may be minimized to a small size and rendered with other AR objects within the video that the user is viewing while traversing the store.

AR router interface 115 provides the AR object(s) to AR app 123 which superimposes them into the video being viewed by the user through the AR app 123 along with the physical environment of the store as the user travels the current segment. The AR object(s) is continuously being streamed and updated by AR router interface 115 based on the remaining distance to the next node provided by tracker 114. Any object provided by the AR router interface 115 that identifies an image of an item to pick/stock within a current segment is also rendered at a bottom of the screen separate from the video within the AR app 123.

When tracker 114 determines that the user is within a configured distance of the next node, a notification is sent to AR router interface 115. AR router interface 115 grabs the next segment from the record for the path, changes the AR object(s) and/or item objects, and sends a notification with the changes to the AR app 123. Upon receiving the changes, the AR app 123 causes a haptic/vibration feedback response on the user device 120 and updates the AR object being blended with the video along with any provided item object. The above-noted process is repeated for each entry in the record (each segment of the path) until the path is completely traversed by the user.

When the user is to pick/stock an item within a current segment, AR router interface 115 inspects the video feed for the item and when recognized provides an AR item object for the item's location within the video to the AR app 123. The AR app 123 blends that into the video at the location for purposes of highlighting the item's location on a shelf within a given aisle. The AR item object may be a mini rendering of an item image for the item or may be an arrow, a circle, or other shape indicator.

In an embodiment, the user device 120 is a phone, a tablet, or a wearable processing device, such as a watch, glasses, or goggles.

In an embodiment, route manager 113, tracker 114, and AR router interface 115 are subsumed within retail server 130 for a specific retailer.

In an embodiment, cloud/server 110 further comprise an Application Programming Interface (API) for connecting to third-party picking services, such as Instacart® or to a specific retailer's picking service (Walmart®, Kroger®, Amazon®, etc.), Shipt®, etc. The API allows a specific list of items for a given order or a given user (customer or picker) and a path through a given store to be obtained by tracker 114 for a given order or given user/customer.

In an embodiment, route manager 113, tracker 114, and AR router interface 115 are subsumed within a third-party picking service server.

In an embodiment, AR app 123 is integrated into and subsumed into an existing third-party picking service's or retailer's mobile ordering application.

In an embodiment. the indoor location is associated with a retail store, a warehouse, a museum, or an entertainment/event venue.

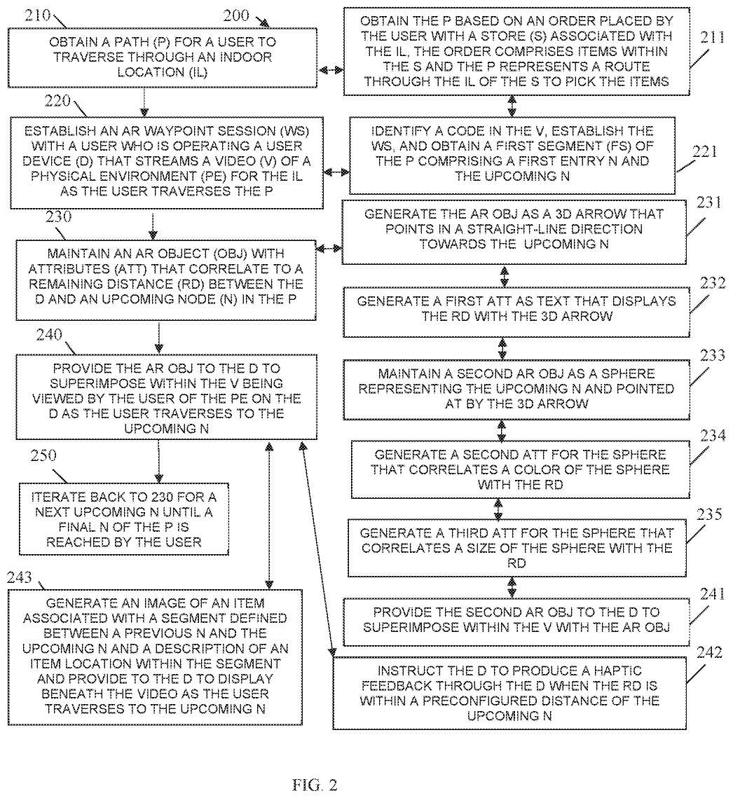

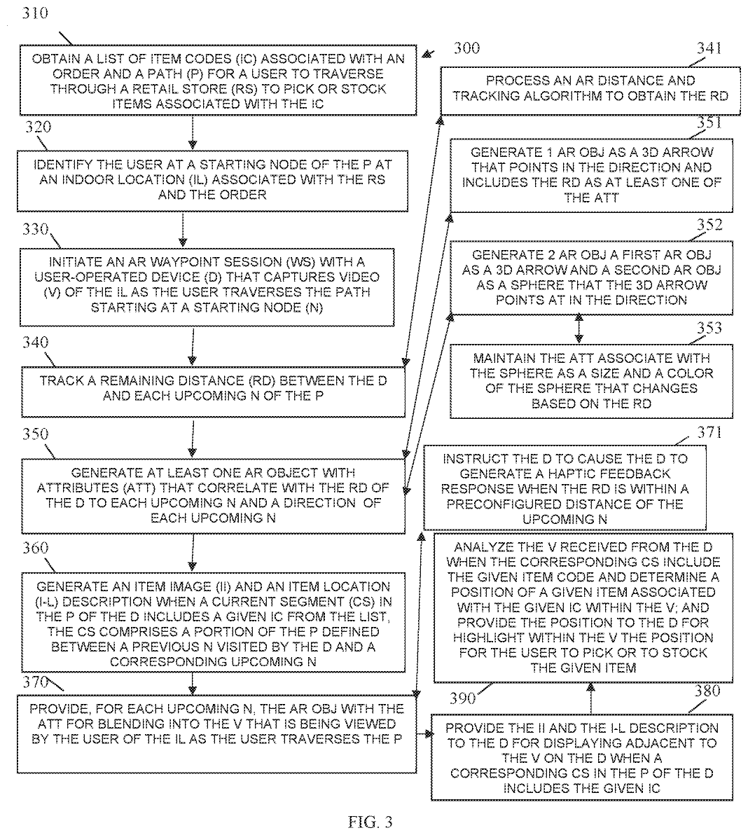

The above-referenced embodiments and other embodiments are now discussed within FIGS. 2 and 3.

FIG. 2 is a diagram of a method 200 for indoor wayfinding, according to an example embodiment. The software module(s) that implements the method 200 is referred to as an “AR indoor wayfinder.” The AR indoor wayfinder is implemented as executable instructions programmed and residing within memory and/or a non-transitory computer-readable (processor-readable) storage medium and executed by one or more processors of one or more devices. The processor(s) of the device that executes the AR indoor wayfinder are specifically configured and programmed to process the AR indoor wayfinder. The AR indoor wayfinder may have access to one or more network connections during its processing. The network connections can be wired, wireless, or a combination of wired and wireless.

In an embodiment, the device that executes the AR indoor wayfinder is a plurality of servers logically cooperating and accessible as a server 110 in the cloud. In an embodiment, the device that executes the AR indoor wayfinder is a server 110 that is separate from any given retail server 130. In an embodiment, the AR indoor wayfinder is all or some combination of 113, 114, and/or 115.

At 210, the AR indoor wayfinder obtains a path for a user to traverse through an indoor location. The manner in which the path is obtained can employ any of the techniques discussed above in connection with system 100. Also, in an embodiment, the path is obtained as a data structure that was generated as a result of an AR mapping session in which anchor objects are scanned via a user AR app at predefined distances beginning at a starting anchor point. Each anchor point has a predefined distance, and the data structure comprises a grid with grid cells corresponding to a physical distance of the anchor points.

In an embodiment, at 211, the AR indoor wayfinder obtains the path based on an order or shopping list placed by a user with a store associated with the indoor location. The order comprises items within the store and the path represents a route through the indoor location of the store to pick the items from shelves/displays along the route.

At 220, the AR indoor wayfinder establishes an AR waypoint session with a user who is operating a user device 120 that streams a video of a physical environment for the indoor location as the user traverses (travels) the path.

In an embodiment of 211 and 220, at 221, the AR indoor wayfinder identifies a code in the video, establishes the AR waypoint session, and obtains a first segment of the path comprising a first entry node and an upcoming node.

At 230, the AR indoor wayfinder maintains an AR object with attributes that correlate to a tracked remaining distance between the user device and the upcoming node in the path.

In an embodiment of 221 and 230, at 231, the AR indoor wayfinder generates the AR object as a 3D arrow that points in a straight-line direction towards the upcoming node.

In an embodiment of 231, and at 232, the AR indoor wayfinder generates a first attribute as text that displays the remaining distance with the 3D arrow.

In an embodiment of 232, and at 233, the AR indoor wayfinder maintains a second AR object as a sphere representing the upcoming node, with the 3D arrow pointing towards the sphere.

In an embodiment of 233, and at 234, the AR indoor wayfinder generates a second attribute for the sphere that correlates a color of the sphere with the remaining distance.

In an embodiment of 234, and at 235, the AR indoor wayfinder generates a third attribute for the sphere that correlates a size or color of the sphere with the remaining distance.

At 240, the AR indoor wayfinder provides the user device 120 with the AR object and its attributes. The user device 120 superimposes and the AR object with its attributes within the video being viewed by the user of the physical environment as the user traverses (travels or moves) to the upcoming node.

In an embodiment of 234 and 240, at 241, the AR indoor wayfinder provides the second AR object with the corresponding attributes to the user device 120 to superimpose within the video with the AR object and its attributes.

In an embodiment, at 242, the AR indoor wayfinder instructs the user device 120 to produce a haptic/vibration feedback response when the remaining distance is within a preconfigured distance of the upcoming node.

In an embodiment, at 243, the AR indoor wayfinder generates an image of an item associated with a segment defined between a previous node and the upcoming node and a description of an item location within the segment and provides this information to the user device 120 to display beneath or adjacent to the video as the user traverses to the upcoming node.

At 250, the AR indoor wayfinder iterates back to 230 for a next upcoming node until a final node of the path is reached by the user.

FIG. 3 is a diagram of another method 300 for indoor wayfinding, according to an example embodiment. The software module(s) that implements the method 300 is referred to as an “AR indoor navigation interface.” The AR indoor navigation interface is implemented as executable instructions programmed and residing within memory and/or a non-transitory computer-readable (processor-readable) storage medium and executed by one or more processors of a device. The processors that execute the AR indoor navigation interface are specifically configured and programmed for processing the AR indoor navigation interface. The AR indoor navigation interface may have access to one or more network connections during its processing. The network connections can be wired, wireless, or a combination of wired and wireless.

In an embodiment, the device that executes the AR indoor navigation interface is the server 110 in a cloud-based configuration. In an embodiment, the device that executes the AR indoor navigation interface is server 110 in a local configuration.

In an embodiment, the AR indoor navigation interface is all of or some combination of 113, 114, 115, and/or method 200 of FIG. 2.

The AR indoor navigation interface presents another and, in some ways, enhanced processing perspective from that which was discussed above for server 110 and method 200.

At 310, the AR indoor navigation interface obtains a list of one or more item codes for a user to traverse (travel) through a retail store to pick or to stock item(s) associated with the item code(s).

At 320, the AR indoor navigation interface identifies the user at a starting node of the path at the indoor location associated with the retail store and the order. This can be achieved via any of the mechanisms discussed above with system 100.

At 330, the AR indoor navigation interface initiates an AR waypoint session with a user-operated device 120 that captures a video of the indoor location as the user traverses the path starting at a first node of the path.

At 340, the AR indoor navigation interface tracks a remaining distance between the user device 120 and each upcoming node of the path.

In an embodiment, at 341, the AR indoor navigation interface processes an AR distance, tracking, and/or mapping algorithm to obtain the remaining distance.

At 350, the AR indoor navigation interface generates at least one AR object with attributes that correlate with the remaining distance of the user device 120 to each upcoming node and a direction of each upcoming node.

In an embodiment, at 351, the AR indoor navigation interface generates one AR object as a 3D arrow that points in the direction of the upcoming node and includes the remaining distance to the upcoming node as at least one of the attributes. Other attributes for the 3D arrow can include a size of the 3D arrow and a color of the 3D arrow that also correlate to and dynamically change as the remaining distance changes, as was discussed above with system 100.

In an embodiment, at 352, the AR indoor navigation interface generates two AR objects, a first AR object as a 3D arrow and a second AR object as a sphere to which the 3D arrow points.

In an embodiment of 352, and at 353, the AR indoor navigation interface maintains the attributes associated with the sphere as a size and a color of the sphere that change based on changes in the remaining distance. Other attributes associated with the 3D arrow that correlate to changes in the remaining distance may include text size, a size of the 3D arrow, and/or a color of the 3D arrow.

At 360, the AR indoor navigation interface generates an item image and an item location description when a current segment in the path of the user device 120 includes a given item code from the list. The current segment comprises a portion of the path of the user device 120 between a previous node visited by the user device 120 and a corresponding upcoming node that the user device 120 is traveling to.

At 370, the AR indoor navigation interface provides, for each upcoming node, the AR object with the corresponding attributes to the user device 120 for blending into the video that is being viewed by the user of the physical environment for the indoor location as the user traverses (travels) the path.

In an embodiment, at 371, the AR indoor navigation interface instructs the user device 120 to cause the user device 120 to generate a haptic/vibration feedback response when the remaining distance is within a preconfigured distance of the upcoming node.

At 380, the AR indoor navigation interface provides the item image and the item location description to the user device 120 for displaying adjacent to the video on the device to the user when a corresponding current segment in the path includes the given item code.

In an embodiment, at 390, the AR indoor navigation interface analyzes the video received from (e.g., streamed from) the user device 120 when the corresponding current segment includes the given item code. The analysis may include applying image recognition to known features associated with a given item that is associated with the given item code. The AR indoor navigation interface determines a position of the given item within the video and the AR indoor navigation interface highlights within the video the position of the item to facilitate retrieval or stocking of the item.

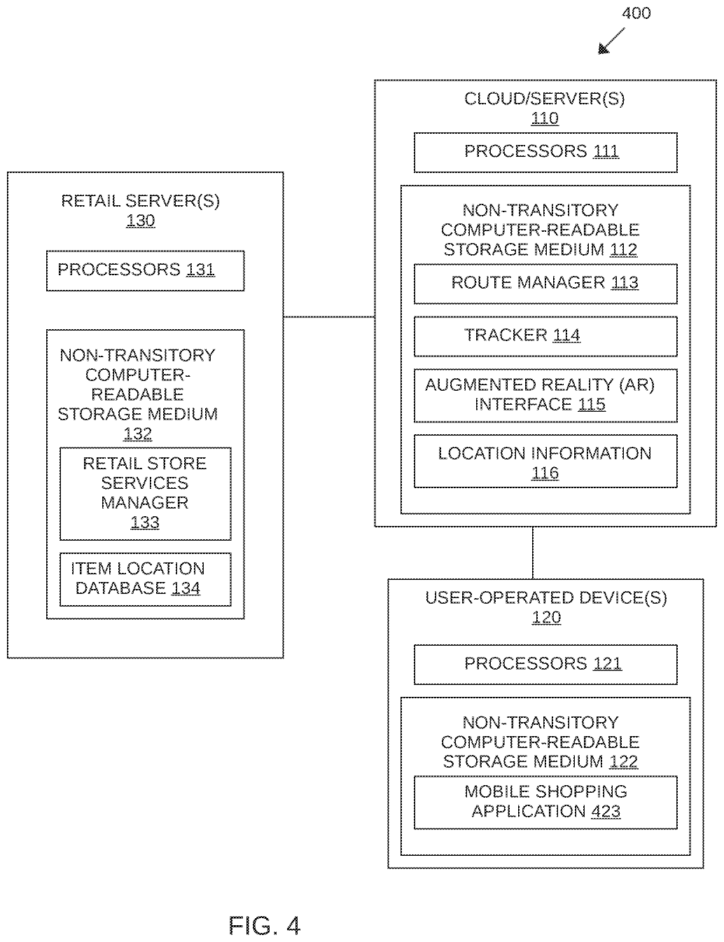

FIG. 4 is a diagram of a system 400 for indoor route mapping based on indoor augmented reality wayfinder technology that is adapted for use with the system and method for collecting item location information of the present disclosure. The API provided in the embodiment of FIG. 1 is supplemented with a location information module 116. System 400 operates to incentivize consumers by providing discounts in exchange for collecting item location data for selected products via a mobile shopping application (app) 423. Mobile shopping app 423 serves as an augmented reality indoor navigation interface and provides all the functionality of AR app 123 described above and adds the item location features described with respect to FIG. 4. This item location data is uploaded to a database for use by other shoppers (e.g., in conjunction with the mobile shopping app 423) or by store employees. In addition, system 400 provides a way to collect item location data in a way that leverages more recent data in order to ensure that the stored item location data is as up to date as possible.

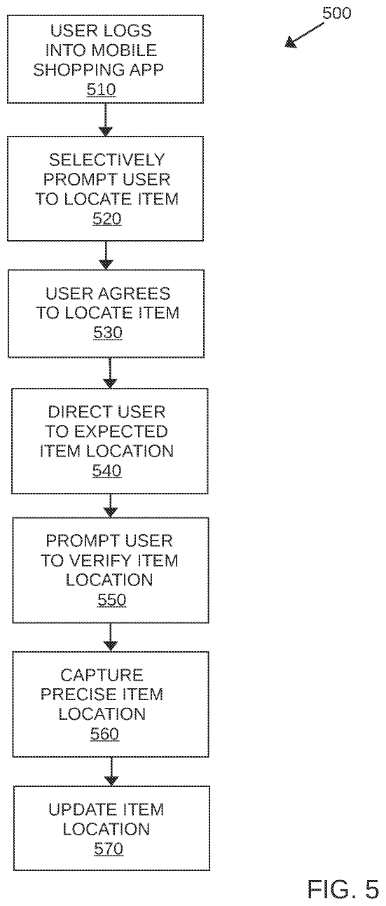

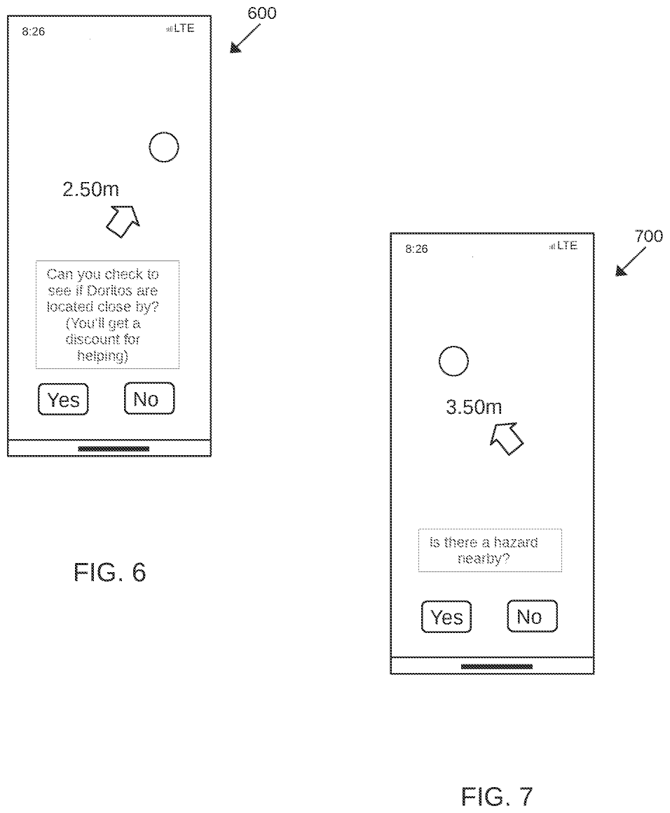

In operation, as shown in the flowchart 500 of FIG. 5, when a customer logs into the mobile shopping app 423 (step 510), system 400 selectively provides a prompt asking them to help locate an item's location (step 520). An example of such prompt is shown in FIG. 6 on a mobile device 600. The prompt on the mobile device requests “Can you check to see if Doritos® are located nearby?” The prompt preferably offers a discount in exchange for this action (e.g., a coupon for that item). In an embodiment, the coupon may be automatically entered into that customer's loyalty account that is linked to the mobile shopping app 423, once the customer locates the item and indicates the location using the mobile shopping app 423. The item location information is then uploaded automatically to the server 110 by the mobile shopping app 423. When a customer agrees to locate an item (step 530), the customer is directed to an expected (e.g., last-known) location of the item based on the item location database 134 by, preferably, using the existing wayfinder controls provided by an AR indoor navigation interface (as above) that is part of the mobile shopping app 423 (step 540). In an alternative embodiment, the customer may receive item location information on the screen of the mobile device and be directed to the location of the item by, instead, providing the customer with information identifying a particular aisle and location within that aisle (e.g., store location coordinates such as an aisle and associated bin or shelf number) where the item should be located. Once at or near the expected location, the customer may then be prompted to verify the product location (step 550) by either a scan (e.g., using barcode reader technology) or visual capture (e.g., taking a photograph using the camera of the mobile device) of the item at the identified location. Once the item location is identified, the precise location within the store is captured (step 560) using, in one embodiment, the indoor location tracking information provided by tracker 114, and the location information is provided to the location information module 116. In another embodiment, the customer manually enters aisle coordinate information (or scans such information) from the shelf on which the item is located into the mobile shopping app 423. By receiving information from users of a mobile shopping app 423, the system and method effectively leverages crowd-sourced data to perform item location.

The location information module 116 accepts the item location data and updates the previously registered location for that item in the item location database 134 (step 570). The previous location data information may be overwritten with the new data or may be updated based on a weighted algorithm that favors more recent customer identifications. In an embodiment, this type of weighted algorithm for updating location takes into consideration the number of location identifications, age of the location scan (e.g., in days), and a shopper reliability score. Naturally, “staler” (less recent) location verifications will be underweighted and phased out of the registered location. In one example, the algorithm is designed to consider only location scans within a predetermined (e.g., 30 day) period of time. Scans older than the predetermined period of time are discarded. In addition, each shopper is assigned a reliability score that is based on previous results. A shopper's reliability score may be increased if it is confirmed that they correctly identified an item location and may be decreased if a predetermined period of time has passed without any confirmation that their location identification was correct. The reliability score for each shopper is preferably determined based at least in part on a measure of the number of previous location attempts that contributed to a registered location and optionally may be impacted by location submissions that never aligned to a registered location, e.g., users having a history of more successful item locations may be weighted higher.

Once a registered location is updated (in the item location database 134) based on new data fed in from the location verification system, the new location will be provided to users for both location-based shopping and future location-based verification efforts. In an embodiment, each shopper's reliability score starts at a fixed number (e.g., 100) and that number may be increased or decreased (only to zero). Once a shopper has completed ten scans, for example, their shopper rank weight may be adjusted beyond their initial rank of one based on a ranking with other shoppers who have also completed ten scans. The shoppers may be ranked linearly between a value of one and two based on their individual reliability scores, with the lowest scoring shopper assigned a value of 1 and the highest scoring shopper assigned a value of two (called the shopperRankWeight below). Based on this ranking, in an embodiment, a location identification may be assigned a weighted score value equal to the sum of [(30−scan age in days)*shopperRankWeight] for each identification at that location. As an example, where there are four location finders, Shopper_A, Shopper_B, Shopper_C, and Shopper_D, and where:

$$Four days ago , Shopper\_A ( having a score of 110 and 15 scans ) located$$

$$Product\_A at aisle 5 , bin A ( Location\_ 1 ) ;$$

$$Four days ago , Shopper\_B ( having a score of 105 and 5 scans ) located Product\_A at aisle 5 , bin A ( Location\_ 1 ) ;$$

$$Two days ago , Shopper\_C ( having a score of 130 and 40 scans ) located$$

$$Product\_A at aisle 6 , bin C ( Location\_ 2 ) ; and$$

$$Eight days ago , Shipper\_D ( having a score of 150 and 100 scans ) located$$

$$Product\_A at aisle 7 , bin D ( Location\_ 3 ) .$$

Applying the example algorithm above, Location_1 is assigned a score of 51 (based on (30-4)*1+(30-5)*1). Location_2 is assigned a score of 42 (based on (30-2)*1.5). Location_3 is assigned a score of 44 (based on 30−8)*2). In this case, Shopper_A has a ranking of 1 as the lowest rank of the three shoppers eligible for ranking, Shopper_B has a ranking of 1 as not yet eligible for ranking, Shopper_C has a ranking of 1.5 as the middle rank of the three shoppers eligible for ranking, and Shopper_D has a ranking of 2 as the highest rank of the three shoppers eligible for ranking.

In most cases, the system will direct the user to the closest item, and if the distance is equal for valid locations, then a shopper's reliability score for a location may be used to decide which location to be provided to the user. In some cases, the mobile shopping app 423 may include a setting that allows a user to elect to be directed to the highest ranked locations in order to have a higher level of confidence that an item will actually be there.

The system 400 also allows for the possibility that an item may be in multiple locations within the same store. When the system receives recent (e.g., within the past seven days) location information for a particular item showing more than one location, the system 400 will register each location and then direct other shoppers—who are looking for that item via their mobile shopping app 423—to the particular location nearest to them within the store (among the multiple stored locations). Once a period of time (e.g., 30 days) has passed with no identifications for an item at a previously stored location, system 400 may remove that location from the item location database 134.

In a further embodiment, the system 400 may be adapted to leverage customer upsells by asking a customer to confirm the location of an item that is a likely upsell. The upsell items may be identified by a compatible loyalty system that provides age-appropriate and/or gender-appropriate choices that a particular shopper may be likely to purchase. Further, coupons may be offered via the mobile shopping app 423 as part of this effort in order to increase the possibility of such upsells. The value of the coupon may be proportional to the amount of use of the location identifying features of the mobile shopping app 423, thereby motivating the shopper to continue to use such features. System 400 thereby adds a new avenue for product promotion and increases customer engagement.

In another further embodiment, the system 400 may be adapted to provide, obtain, and process customer reports of a potentially hazardous condition like spilled liquids, broken glass, cold items left out and potentially hazardous, etc. The mobile shopping app 423 may include a button to select a hazard report, and the screen that appears on a device 700 shown in FIG. 7 may be provided upon selection of such a button. The reported hazards are then marked as locations for the route manager 113 to avoid. In a further embodiment, the reporting of hazards may be scored and weighted in a manner similar to that discussed above with respect to item location. Still further, the system 400 may be adapted to provide messages to the user (shopper) asking to confirm that a hazard remains present in a particular location.

Although the present disclosure has been particularly shown and described with reference to the preferred embodiments and various aspects thereof, it will be appreciated by those of ordinary skill in the art that various changes and modifications may be made without departing from the spirit and scope of the disclosure. It is intended that the appended claims be interpreted as including the embodiments described herein, the alternatives mentioned above, and all equivalents thereto. It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner. Furthermore, although the software modules are illustrated as executing on one piece of hardware, the software may be distributed over multiple processors or in any other convenient manner.

What is claimed is:

1. A method, comprising:
selectively requesting a user of a mobile shopping application on a mobile device to locate an item in a retail store via the mobile shopping application, the user being one of a plurality of users;
directing the user to an expected location of the item via the mobile shopping application;
receiving confirmation from the user that the item has been located via the mobile shopping application;
capturing a precise location of the item in conjunction with the mobile shopping application; and
updating an item location database to include the captured precise location of the item.

2. The method of claim 1, further comprising offering to the user, via the mobile shopping application, a coupon in exchange for locating the item within the retail store.

3. The method of claim 1, wherein the user is directed to the expected location of the item via an augmented reality indoor navigation interface provided via the mobile shopping application.

4. The method of claim 1, wherein the user is directed to the expected location of the item by providing store location coordinates via the mobile shopping application.

5. The method of claim 1, wherein the user confirms a location of the item by capturing a photograph of the item via the mobile shopping application.

6. The method of claim 1, wherein the user confirms a location of the item by capturing a barcode on the item via the mobile shopping application.

7. The method of claim 1, wherein the precise location of the item is captured by a tracker module operating in conjunction with the mobile shopping application that monitors user movements via the mobile shopping application.

8. The method of claim 1, wherein the item location database is updated based on a weighted algorithm that gives more weight to more recent location identifications by users.

9. The method of claim 1, wherein the item location database is updated based on a weighted algorithm that gives more weight to location identifications by users having a history of more successful item locations.

10. The method of claim 1, further comprising receiving a notification from the user of a location of a potentially hazardous condition within the retail store.

11. A system, comprising:
a server having a processor and a non-transitory computer-readable storage medium, the server coupled to a mobile shopping application on a mobile device of a user, the non-transitory computer-readable storage medium having executable instructions, which when executed, cause the processor to perform the following operations:
selectively request the user of the mobile shopping application on the mobile device to locate an item in a retail store via the mobile shopping application;
direct the user to an expected location of the item via the mobile shopping application;
receive confirmation from the user that the item has been located via the mobile shopping application;
capture a precise location of the item in conjunction with the mobile shopping application; and
update an item location database to include the captured precise location of the item.

12. The system of claim 11, further comprising executable instructions which cause the processor to offer to the user, via the mobile shopping application, a coupon in exchange for locating the item within the retail store.

13. The system of claim 11, wherein the user is directed to the expected location of the item via an augmented reality indoor navigation interface provided via the mobile shopping application.

14. The system of claim 11, wherein the user is directed to the expected location of the item by providing store location coordinates via the mobile shopping application.

15. The system of claim 11, wherein the user confirms a location of the item by capturing a photograph of the item via the mobile shopping application.

16. The system of claim 11, wherein the user confirms a location of the item by capturing a barcode on the item via the mobile shopping application.

17. The system of claim 11, wherein the precise location of the item is captured by a tracker module operating in conjunction with the mobile shopping application that monitors user movements via the mobile shopping application.

18. The system of claim 11, wherein the item location database is updated based on a weighted algorithm that gives more weight to more recent location identifications by users.

19. The system of claim 11, wherein the item location database is updated based on a weighted algorithm that gives more weight to location identifications by users having a history of more successful item locations.

20. The system of claim 11, further comprising executable instructions which cause the processor to receive a notification from the user of a location of a potentially hazardous condition within the retail store.
